(19) United States
(12) Patent Application Publication
(10) Pub. No.: US 2026/0088984 A1
(43) Pub. Date: Mar. 26, 2026

(54) INFORMATION PROCESSING DEVICE AND SYSTEM, AND IN-VEHICLE ELECTRONIC DEVICE

(71) Applicant: HITACHI ASTEMO, LTD., Hitachinaka-shi, Ibaraki (JP)

(72) Inventors: Shugo MIKAMI, Hitachinaka-shi, Ibaraki (JP); Yasuhiro FUJII, Hitachinaka-shi, Ibaraki (JP); Teruaki NOMURA, Hitachinaka-shi, Ibaraki (JP); Mikio KATAOKA, Hitachinaka-shi, Ibaraki (JP)

(73) Assignee: HITACHI ASTEMO, LTD., Hitachinaka-shi, Ibaraki (JP)

(21) Appl. No.: 19/111,129

(22) PCT Filed: Dec. 12, 2022
(86) PCT No.: PCT/JP2022/045591

§ 371 Date: Mar. 12, 2025

(51) Int. Cl. H04L 9/08; G06F 21/57; H04L 9/30

(52) U.S. Cl. CPC H04L 9/0861; G06F 21/572; H04L 9/3073

(57) ABSTRACT

An information processing device according to the present invention includes: a storage unit that stores a unique number that identifies a vehicle or an in-vehicle electronic device; a vehicle selection unit that selects a vehicle to which update software is applied; a key generation unit that generates a secret key using, as a public key, at least one of the unique number of the selected vehicle or the in-vehicle electronic device mounted on the vehicle; an encryption unit that generates encrypted update software by encrypting the update software using the secret key; and a distribution unit that distributes the encrypted update software to the vehicle.

### TECHNICAL FIELD

The present invention relates to not only an information processing device and a system that perform distribution and update control of in-vehicle software for update between a software update management center connected to a network and an in-vehicle electronic device, but also the in-vehicle electronic device to which software is distributed.

### BACKGROUND ART

Vehicles such as automobiles are each equipped with a plurality of in-vehicle electronic devices called electric control units (ECUs) that perform functions such as engine control, brake control, and safety control, and these functions are implemented by in-vehicle software. To implement functions such as automatic driving and driving support, the in-vehicle electronic devices described above are recently connected to each other through an in-vehicle network and coordinated with each other, and in-vehicle software has also increased. Consequently, security threats including illegal communication such as eavesdropping of communication data in an in-vehicle network and insertion of illegal data, and falsification of in-vehicle software, have increased.

To protect a vehicle function from security threats as described above, a vehicle or an in-vehicle electronic device stores and uses many different keys for each function, such as a secret key for encrypting and decrypting communication data and a verification key for detecting falsification of in-vehicle software or the like. Additionally, software over the air (SOTA) that distributes and updates in-vehicle software via wireless communication has become widespread for correcting bugs and vulnerabilities that are weak points in security of in-vehicle software, and adding functions, for example. SOTA functions and functions implemented by newly added in-vehicle software are increased, so that keys stored in vehicles and in-vehicle electronic devices, and keys issued and managed by a key management center, will be increased in the future.

Meanwhile, the in-vehicle electronic device has a limited hardware resource such as a memory for storing data, and has a limited area in which data such as a key can be safely stored, and thus loading key management.

PTL 1 describes a technique of the key management, the technique including a method of: holding a user secret key in a device; allowing a user to issue an access request including a user secret key including access right information; and decrypting an in-vehicle function program encrypted with the access right information and the user secret key when the access request is matched.

### CITATION LIST

### Patent Literature

PTL 1: WO 2019/224912 A

### SUMMARY OF INVENTION

### Technical Problem

The method described in PTL 1 requires a user to have a new device such as an integrated card (IC) card for storing a user secret key necessary for use of an in-vehicle function. Additionally, the user secret key needs to be written to the device each time the user or the access right information of the user changes, and thus causing a risk of erroneous setting such as erroneous writing of a value of the user secret key.

The present invention has been made in view of the above problems, and an object of the present invention is to provide an information processing device, a system, and an in-vehicle electronic device capable of suppressing an increase in a key management load while implementing update and use of in-vehicle software even when the in-vehicle electronic device has no margin in a storage region.

### Solution to Problem

To achieve the above object, an information processing device according to the present invention includes: a storage unit that stores a unique number that identifies a vehicle or an in-vehicle electronic device; a vehicle selection unit that selects a vehicle to which update software is applied; a key generation unit that generates a secret key using, as a public key, at least one of the unique number of the vehicle selected and the unique number of the in-vehicle electronic device mounted on the vehicle; an encryption unit that encrypts the update software using the secret key to generate encrypted update software; and a distribution unit that distributes the encrypted update software to the vehicle.

### Advantageous Effects of Invention

According to the present invention, using identification information on a vehicle or an in-vehicle electronic device as a decryption key not only requires no new key for updating or using in-vehicle software to be stored in a non-writable region of the vehicle, but also enables reducing a risk of erroneous setting of a key value. Additionally, a management center uses identification information on the vehicle or the in-vehicle electronic device as the decryption key, so that the number of keys managed for each vehicle is not increased, and thus a load of key management can be prevented from increasing.

Further features related to the present invention will become apparent from the description herein and the accompanying drawings. Problems, configurations, and effects other than the above will be clarified by the following description of an embodiment.

### BRIEF DESCRIPTION OF DRAWINGS

FIG. 1 is a block diagram illustrating a general configuration of an information processing system according to one embodiment of the present invention.

FIG. 2 is a block diagram illustrating a hardware configuration of a vehicle.

FIG. 3 is a block diagram illustrating a hardware configuration of an in-vehicle electronic device.

FIG. 4 is a block diagram illustrating a hardware configuration of a management center.

FIG. 5 is a processing flow illustrating software distribution preparation processing, software distribution processing, and software update processing, which are performed by the information processing system according to one embodiment of the present invention.

FIG. 6 is a processing flow illustrating the software distribution preparation processing performed by the information processing system.

FIG. 7 is a processing flow illustrating software distribution processing performed by the information processing system.

FIG. 8 is a processing flow illustrating software update processing performed by the information processing system.

FIG. 9 is an example of a screen on which a user selects a vehicle to which update software is applied in the management center.

FIG. 10 is a diagram illustrating a configuration of vehicle management information stored in the management center.

FIG. 11 is a diagram illustrating a configuration of software information stored in the management center.

### DESCRIPTION OF EMBODIMENTS

### First Embodiment

Hereinafter, an embodiment of the present invention will be described with reference to the drawings.

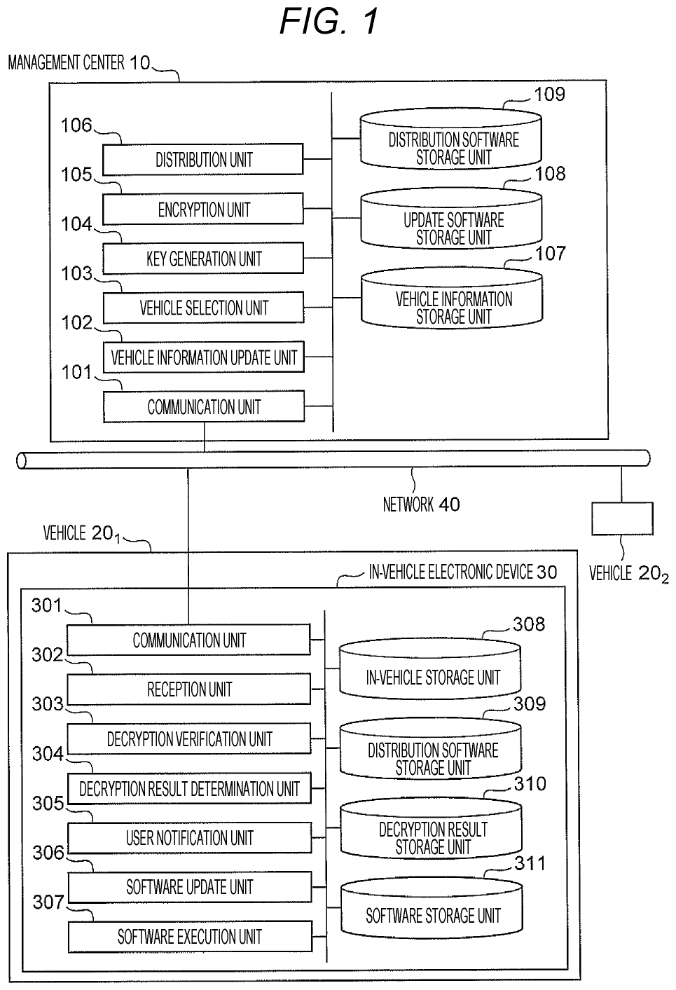

FIG. 1 is a block diagram illustrating general configuration of an information processing system according to one embodiment of the present invention. The information processing system includes a management center 10, vehicles 201 and 202, and a network 40. Although two vehicles 201 and 202 are present in FIG. 1, one vehicle, or three or more vehicles may be provided. When the vehicles 201 and 202 are not distinguished, they may be simply referred to as vehicles 20 without a subscript. The information processing system according to the present embodiment performs update control of in-vehicle software mounted on a vehicle.

The management center 10 is a computer including a central processing unit (CPU) and a memory that perform vehicle management, and management and distribution of in-vehicle software. The management center 10 includes a communication unit 101 that performs communication through the network 40, a vehicle information update unit 102 that updates in-vehicle software application information on a vehicle, a vehicle selection unit 103 that selects the vehicle to which update software is applied, a key generation unit 104 that generates an encrypted key in which identification information on the vehicle selected serves as a decryption key, an encryption unit 105 that encrypts the update software using the encrypted key, a distribution unit 106 that distributes the update software that has been encrypted to the vehicle, a vehicle information storage unit 107 that stores the identification information on the vehicle and the in-vehicle software information applied, an update software storage unit 108 that stores the update software, and a distribution software storage unit 109 that stores encrypted update software to be distributed to the vehicle.

A vehicle 20 is equipped with an in-vehicle electronic device 30. Although one in-vehicle electronic device 30 is present in FIG. 1, two or more in-vehicle electronic devices 30 may be provided. The in-vehicle electronic device 30 includes a communication unit 301 that performs communication through the network 40, a reception unit 302 that receives encrypted update software from the management center 10, a decryption verification unit 303 that decrypts the encrypted update software, a decryption result determination unit 304 that determines a decryption result, a user notification unit 305 that notifies a user of the vehicle that the update software has been received and accepts installation permission of the update software from the user, a software update unit 306 that updates the in-vehicle software, a software execution unit 307 that executes the in-vehicle software, an in-vehicle storage unit 308 that stores identification information on the in-vehicle electronic device and the in-vehicle software, a distribution software storage unit 309 that stores the encrypted update software received from the management center 10, a decryption result storage unit 310 that stores a result of decrypting the encrypted update software using the identification information, and a software storage unit 311 that stores the in-vehicle software.

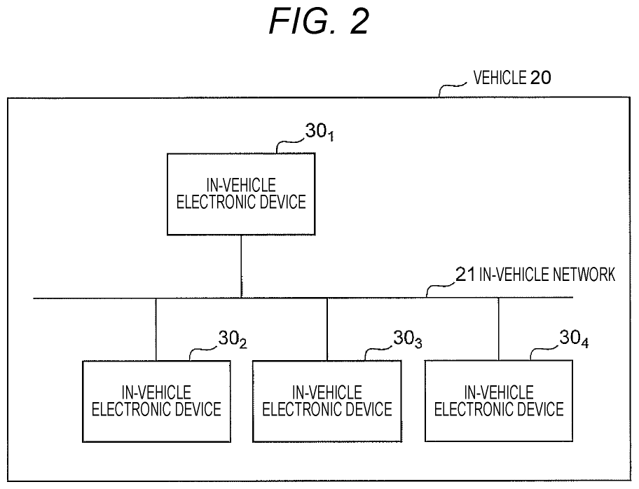

FIG. 2 is a block diagram illustrating a hardware configuration of the vehicle 20. The vehicle 20 includes in-vehicle electronic devices 301, 302, 303, and 304 that are connected through an in-vehicle network 21. Although four in-vehicle electronic devices 301, 302, 303, and 304 are present in FIG. 2, the number of the in-vehicle electronic devices may be one or any number of two or more. The in-vehicle electronic devices 301, 302, 303, and 304 may include a master device that controls an in-vehicle electronic device other than its own, a slave device that receives an instruction from an in-vehicle electronic device other than its own, and a proxy device or a gateway device that mediates and converts communication of two or more different in-vehicle electronic devices other than its own. When the in-vehicle electronic devices 301, 302, 303, and 304 are not distinguished, they may be simply referred to as in-vehicle electronic devices 30 without a subscript. Examples of the in-vehicle network 21 include a control area network (CAN), and Ethernet, and a plurality of in-vehicle networks may be present, and also the in-vehicle networks are not limited thereto

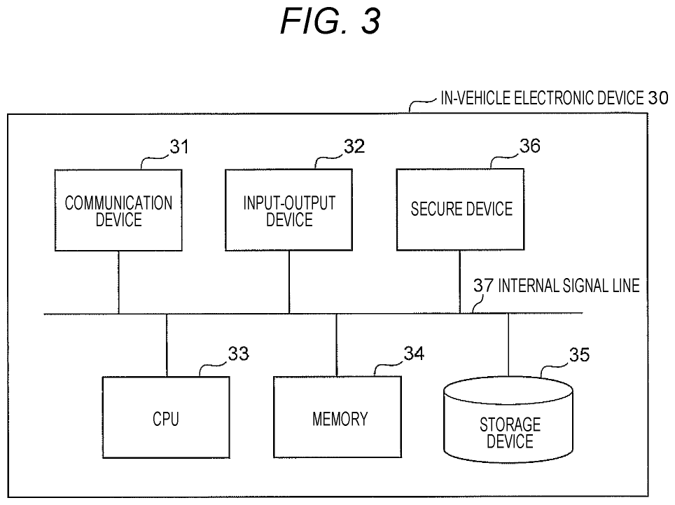

FIG. 3 is a block diagram illustrating a hardware configuration of the in-vehicle electronic device 30. The in-vehicle electronic device 30 includes a communication device 31, an input-output device 32, a CPU 33, a memory 34, a storage device 35, and a secure device 36 that are connected by an internal signal line 37 such as a bus. The secure device 36 is here an arithmetic device including a storage area with high security, examples of the storage area including: a storage area that cannot be physically rewritten; a storage area that can be rewritten only once; and a storage area in which access control such as authentication of a user a process is set. Specific examples the arithmetic device include a device such as a hardware security module (HSM) that not only stores a key for encryption and decryption, a digital signature for verification of software or the like, an electronic certificate, a setting value, a verification value, identification information, and the like, but also performs encrypted decryption processing, verification processing, and the like.

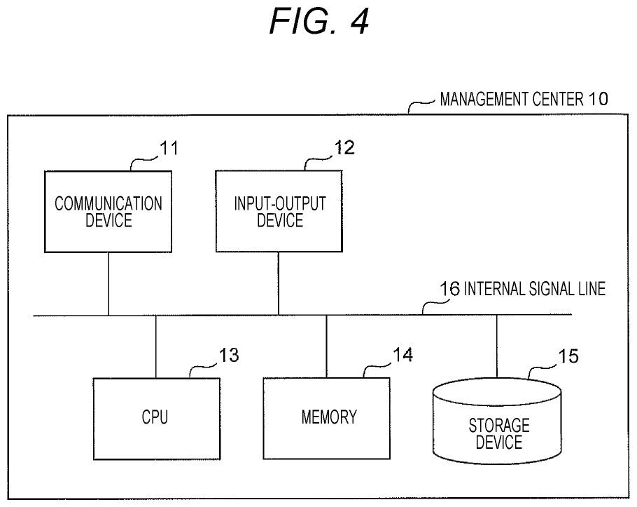

FIG. 4 is a block diagram illustrating a hardware configuration of the management center 10. The management center 10 includes a communication device 11, an input-output device 12, a CPU 13, a memory 14, and a storage device 15 that are connected by an internal signal line 16. Examples of the input-output device 12 include a keyboard, a mouse, a touch panel, a numeric keypad, a scanner, a microphone, a sensor, a display, a printer, and a speaker. The communication device 11 functions as the communication unit 101 in FIG. 1, and is connected to the network 40 to transmit and receive data.

Subsequently, a processing flow in the information processing system of the present embodiment will be described. The processing flow described below is performed by each processing unit embodied on a device constructing the in-vehicle software update control system by loading a program stored in the storage device of the management center 10 or the in-vehicle electronic device 30 into the memory and executing the program by the CPU. Each program may also be introduced as needed using another storage medium or a communication medium (a network or a transmission wave propagating through the network).

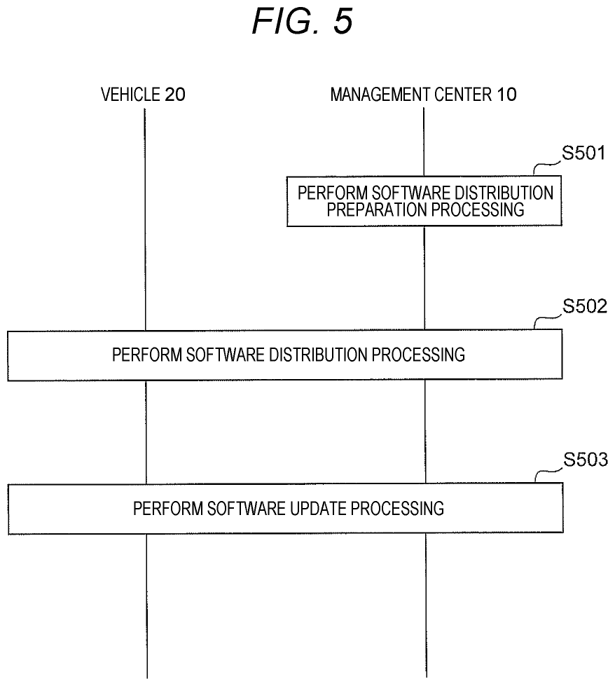

FIG. 5 is a diagram illustrating an example of a processing flow performed by the information processing system according to one embodiment of the present invention in the management center 10 and the vehicle 20, the processing flow including: performing update software distribution preparation; performing update software distribution; and performing in-vehicle software update.

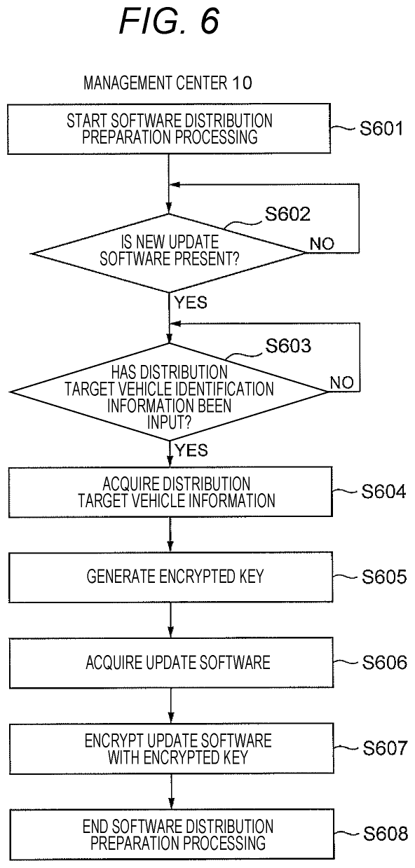

First, the management center 10 performs software distribution preparation processing (step S501). Next, the management center 10 and the vehicle 20 perform software distribution processing (step S502). Here, one vehicle 20 or a plurality of vehicles 20 may be provided. Next, the management center 10 and the vehicle 20 perform software update processing (step S503). Details of each processing will be described with reference to FIG. 6 to 8.

FIG. 6 is a diagram illustrating an example of a processing flow of the software distribution preparation processing S501 performed by the management center 10.

First, the management center 10 activates an application to start the software distribution preparation processing (step S601). Next, the management center 10 determines whether there is new update software (step S602). Here, the management center 10 may receive the update software from an update software creation center or an update software creation department (not illustrated) through the network 40, or may receive the update software using an external storage medium (not illustrated) such as a digital versatile disc (DVD) or a universal serial bus (USB) memory. The update software received is stored in the update software storage unit 108.

In the processing of step S602, the management center 10 reads the update software storage unit 108 to determine whether new update software is registered. Although examples of a method for determining whether the new update software is registered include: a method for comparing time information on previous determination with time information on the in-vehicle software registered in the update software storage unit 108 to determine that the in-vehicle software is newly registered when the time information on the in-vehicle software registered is newer than the time information on previous determination; a method for comparing the number of entries of the in-vehicle software determined last time with the number of current entries of the in-vehicle software to determining that the in-vehicle software is newly registered when the number of current entries is larger than the number of entries last time; and a method for giving a distributed flag to the in-vehicle software distributed to the vehicle to determine that the in-vehicle software is the newly registered in-vehicle software when there is no distributed flag, any combination or any execution order of these methods may be used, and the determination method is not limited to these methods.

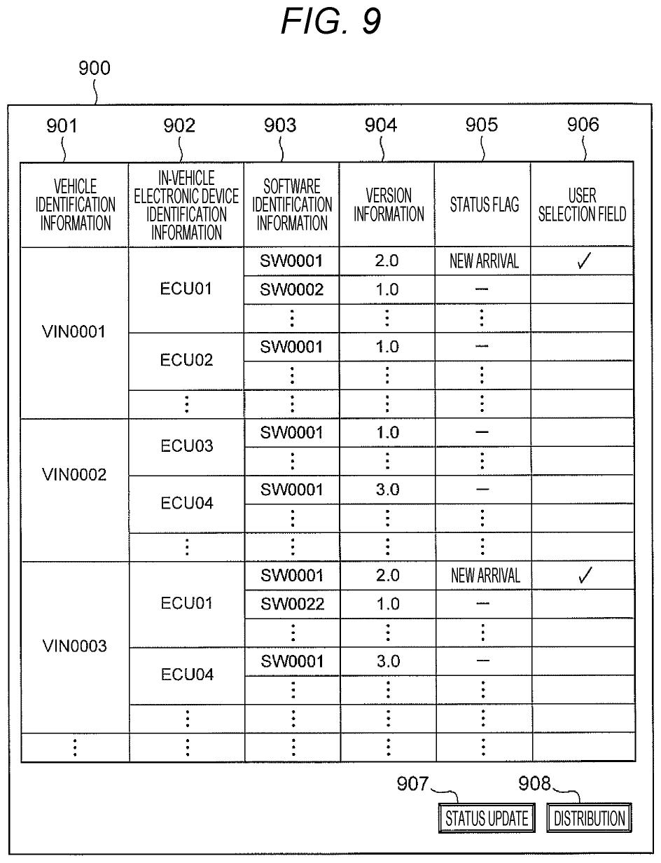

When determining that there is no new update software, the management center 10 is still on standby. In contrast, when determining that there is new update software, the management center 10 determines whether distribution target vehicle identification information has been received (step S603). Here, the distribution target vehicle identification information is received from a user of the management center 10, using the vehicle selection unit 103. An example of an input screen of the user is illustrated in FIG. 9 described later. Examples of the distribution target vehicle identification information include a vehicle identification number (VIN), an ECU ID, a serial number, a model and a model number of hardware, a name and a version number of an operating system (OS), a name of in-vehicle software, and a version number of in-vehicle software, and any combination or any order thereof may be used, and also the distribution target vehicle identification information is not limited thereto.

When determining that the distribution target vehicle identification information is not received, the management center 10 is still on standby. In contrast, when determining that the distribution target vehicle identification information is received, the management center 10 acquires the distribution target vehicle identification information (step S604).

Next, the management center 10 performs encrypted key generation processing using the distribution target vehicle identification information (step S605). In step S605, the key generation unit 104 creates an encrypted key using attribute-based encryption, the encrypted key including a decryption key that is the distribution target vehicle identification information acquired in step S604.

Here, the attribute-based encryption is a type of public key encryption that is an encryption scheme in which an encrypted key and a decryption key have different values, and is encryption based on a pairing operation that is a mapping from a set of two points on an elliptic curve to a finite field. The attribute-based encryption is a kind of extension of ID-based encryption, and is not only an encryption scheme in which not only an arbitrary value or a character string can be used as a public key, but also a relationship between an encryption key and a public key is 1 to n, but also an encryption scheme in which a plurality of arbitrary values or character strings obtained by combining AND and OR relationships can be used as a public key.

In step S605, an encrypted key (encryption key) in which VIN1 or VIN3 is a decryption key (public key) is created by attribute-based encryption, when VIN1 and VIN3 are selected as the distribution target vehicle identification information in step S604 and VIN2 is excluded from the distribution target, for example. That is, the distribution target vehicle identification information is used as the arbitrary value or the character string described above, in step S605.

Next, the management center 10 acquires update software to be distributed to the vehicle (step S606). Here, the update software is determined to be new update software in step S602. Next, the management center 10 encrypts the update software with the encrypted key (step S607). The encrypted key is the encrypted key created from the distribution target vehicle identification information using the attribute-based encryption in step S605, and the encryption unit 105 encrypts the update software acquired in step S606 using the encrypted key to create the encrypted update software. The encrypted update software is stored in the distribution software storage unit 109. In this way, the vehicle identification information can be used as the decryption key by using the attribute-based encryption, so that a key for decrypting the encrypted update software is not required to be separately prepared. Next, the management center 10 ends the software distribution preparation processing (step S608). Step S606 may be performed before step S603 or step S604, and the processing order may be appropriately determined.

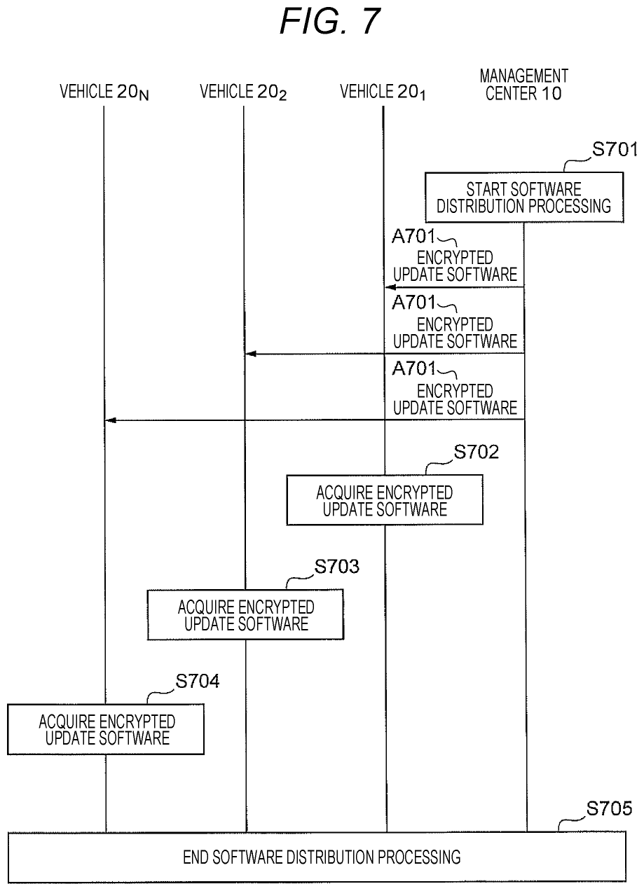

FIG. 7 is a diagram illustrating an example of a processing flow of the software distribution processing S502 performed by the management center 10 and the vehicle 20 in the information processing system according to one embodiment of the present invention. Although FIG. 7 illustrates N vehicles (vehicle 201, 202 to 20N), the number of vehicles may be any number of one or more.

First, the management center 10 activates an application to start the software distribution processing (step S701). Here, the management center 10 includes the distribution unit 106 that reads the encrypted update software from the distribution software storage unit 109, and transmits the encrypted update software (A701) to all the vehicles having the vehicle identification information stored in the vehicle information storage unit 107 through the network 40.

The network 40 here may be not only wireless communication such as long term evolution (LTE), 4G, 5G, wireless fidelity (Wi-Fi), or Bluetooth, but also a wired local area network (LAN). The network 40 may perform encryption of a communication path, or partial or mutual authentication by a communication protocol such as security architecture for internet protocol (IPsec), secure socket layer (SSL), transport layer security (TLS), or secure shell (SSH).

Next, the vehicle 201 acquires the encrypted update software (step S702). The reception unit 302 in the in-vehicle electronic device 30 of the vehicle 201 stores the encrypted update software received by the communication unit 301 from the network 40 in the distribution software storage unit 309. Next, the vehicle 202 acquires the encrypted update software (step S703). The reception unit 302 in the in-vehicle electronic device 30 of the vehicle 202 stores the encrypted update software received by the communication unit 301 from the network 40 in the distribution software storage unit 309.

Next, the vehicle 20N acquires the encrypted update software (step S704). The reception unit 302 in the in-vehicle electronic device 30 of the vehicle 20N stores the encrypted update software received by the communication unit 301 from the network 40 in the distribution software storage unit 309. Finally, the management center 10 and the vehicle 20 end the software distribution processing (step S705). Here, the processing order of S702 to S704 may be appropriately determined, and may be performed simultaneously in parallel besides a method for performing the processing sequentially.

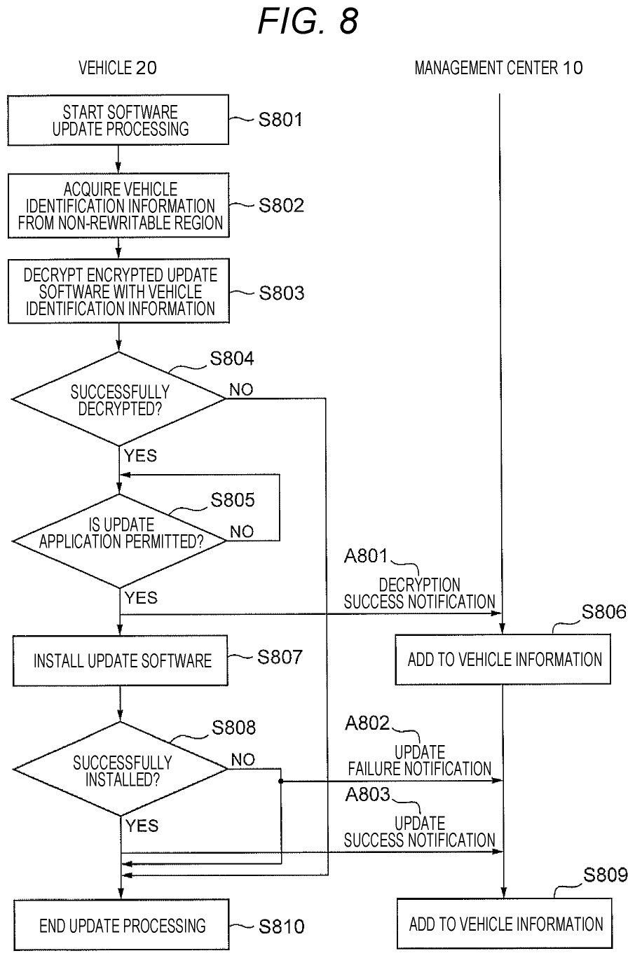

FIG. 8 is a diagram illustrating an example of a processing flow of the software update processing step S503 performed by the management center 10 and the vehicle 20 in the information processing system according to one embodiment of the present invention. Although FIG. 8 illustrates one vehicle (vehicle 20), the number of vehicles may be any number of one or more.

First, the vehicle 20 activates an application to start software update processing (step S801). Next, the vehicle 20 acquires vehicle identification information from a non-rewritable region (step S802). Here, the decryption verification unit 303 reads out the vehicle identification information from the in-vehicle storage unit 308 More specifically, the vehicle identification information stored in the non-rewritable region of the secure device 36 is read out.

Next, the vehicle 20 decrypts the encrypted update software using its own identification information (step S803). Here, the encrypted update software read out from the distribution software storage unit 309 is decrypted using the vehicle identification information read out from the in-vehicle storage unit 308 by the decryption verification unit 303, and is stored in the decryption result storage unit 310. In this way, the vehicle identification information can be used as the decryption key of the encrypted update software, so that the decryption key is not required to be separately stored in the non-rewritable region of the vehicle.

Next, the vehicle 20 determines whether the encrypted update software has been successfully decrypted (step S804). Although examples of a method here for determining whether the decryption succeeds include a method including: adding a hash value, a checksum, a message authentication code (MAC) value, or a digital signature to update software; calculating a hash value, a checksum, a MAC value, or a signature value for software obtained by decrypting the encrypted update software using the decryption result determination unit 304; verifying whether the value calculated matches the value added to the update software; determining that the decryption succeeds when the values match; and determining that the decryption fails when the values do not match, any one of the hash value, the checksum, the MAC, and the digital signature may be combined, and the combination order may be appropriately determined, and also the determination is not limited to this method.

When it is determined that the decryption fails, the update processing ends (step S810). In contrast, when it is determined that the decryption succeeds, it is determined whether update application is permitted (step S805). Although examples of a method for determining whether update application is permitted include a method for determining whether update permission is received from the user by viewing a user screen (not illustrated) displayed using the input-output device 32 of the in-vehicle electronic device 30, the method is not limited thereto.

When it is determined that the update application is not permitted, the processing is still on standby. In contrast, when it is determined that the update is permitted, the vehicle 20 transmits a decryption success notification (A801) to the management center 10. Although the communication unit 301 transmits the decryption success notification to the communication unit 101 of the management center 10 through the network 40, the network 40 may be wireless communication such as LTE, 4G, 5G, Wi-Fi, or Bluetooth, or may be a wired LAN. The network 40 also may be subjected to encryption of a communication path, or partial or mutual authentication, using communication protocol such as IPsec, SSL, TLS, or SSH.

Next, the management center 10 adds information regarding the decryption success to the vehicle information (step S806). Here, the vehicle information update unit 102 adds the decryption success notification (A801) received by the communication unit 101 to the corresponding entry of the vehicle information storage unit 107. Although examples of a method for adding the notification include a method for providing a status flag field in the vehicle information storage unit 107 and inputting information on decryption success in the status flag field, the method is not limited thereto.

When it is determined that application is permitted in step S805, the vehicle 20 installs the update software (step S807). Here, the software update unit 306 reads out the update software from the decryption result storage unit 310 and installs the update software.

Next, the vehicle 20 determines whether the update software has been successfully installed (step S808). When the installation fails, the vehicle 20 transmits an update failure notification (A802) to the management center 10. The communication unit 301 here transmits the update failure notification (A802) to the communication unit 101 of the management center 10 through the network 40. The transmission of A802 may be performed along with encryption of a communication path or authentication, as with the transmission of A801.

The management center 10 adds information on the update failure to the vehicle information (step S809). Here, the update failure notification (A802) received by the vehicle information update unit 102 in the communication unit 101 is added to the corresponding entry of the vehicle information storage unit 107. Examples of a method for adding the notification include not only a method for providing a status flag field in the vehicle information storage unit 107 and inputting the information on the update failure in the status flag field, but also a method for adding the notification to information on the decryption success or overwriting the information on the decryption success, and the method is not limited thereto.

When the vehicle 20 succeeds in installing the update software, the vehicle 20 transmits an update success notification (A803) to the management center 10. The communication unit 301 here transmits the update success notification (A803) to the communication unit 101 of the management center 10 through the network 40. The transmission of A803 may be performed along with encryption of a communication path or authentication, as with the transmission of each of A801 and A802.

The management center 10 adds information on the update success to the vehicle information (step S809). Here, the update success notification (A803) received by the vehicle information update unit 102 in the communication unit 101 is added to the corresponding entry of the vehicle information storage unit 107. Examples of a method for adding the notification include not only a method for providing a status flag field in the vehicle information storage unit 107 and inputting the information on the update success in the status flag field, but also a method for adding the notification to information on the decryption success or overwriting the information on the decryption success, and the method is not limited thereto. Finally, the vehicle 20 ends the application to end the update processing (step S810).

FIG. 9 is an example of a screen displayed on the management center 10 on which the user selects a vehicle to which the update software is applied. A vehicle selection screen 900 is displayed on a display that is an example of the input-output device 12. On the vehicle selection screen 900, vehicle identification information 901, in-vehicle electronic device identification information 902, software identification information 903, version information 904, a status flag 905, a user selection field 906, a status update button 907, and a distribution button 908 are displayed.

As the vehicle identification information 901, a vehicle identifier such as VIN is displayed, for example. As the in-vehicle electronic device identification information 902, an identifier of the in-vehicle electronic device such as ECU ID is displayed. As the software identification information 903, a software identifier such as a software name or a software ID of in-vehicle software is displayed.

As the version information 904, the version number of the in-vehicle software is displayed. As the status flag a status of the in-vehicle software is displayed. Although examples of the status include newly arrived, distributed, decrypted, and installed, the status is not limited to the examples. In the user selection field 906, the user can input a check mark, and a vehicle to which the update software is applied can be selected by inputting the check mark. One check mark or a plurality of check marks may be input.

The status update button 907 is used not only to update the status of the status flag 905 when a response as update information of the status flag 905 has been received from the vehicle 20, but also to additionally display new update software on the vehicle selection screen 900 when the management center 10 has received the new update software. The update of the status flag 905 and the display of the new update software may be automatically read on the vehicle selection screen 900 periodically, or may be read when the status update button 907 is pressed. Alternatively, these methods may be combined. When the user presses the distribution button 908 after finishing the vehicle selection, generation of an encrypted key is started in which the identification information with a check mark in the user selection field 906 serves as a decryption key. Components of the vehicle selection screen 900 are not limited to the above, and the order of the components is not limited to the above.

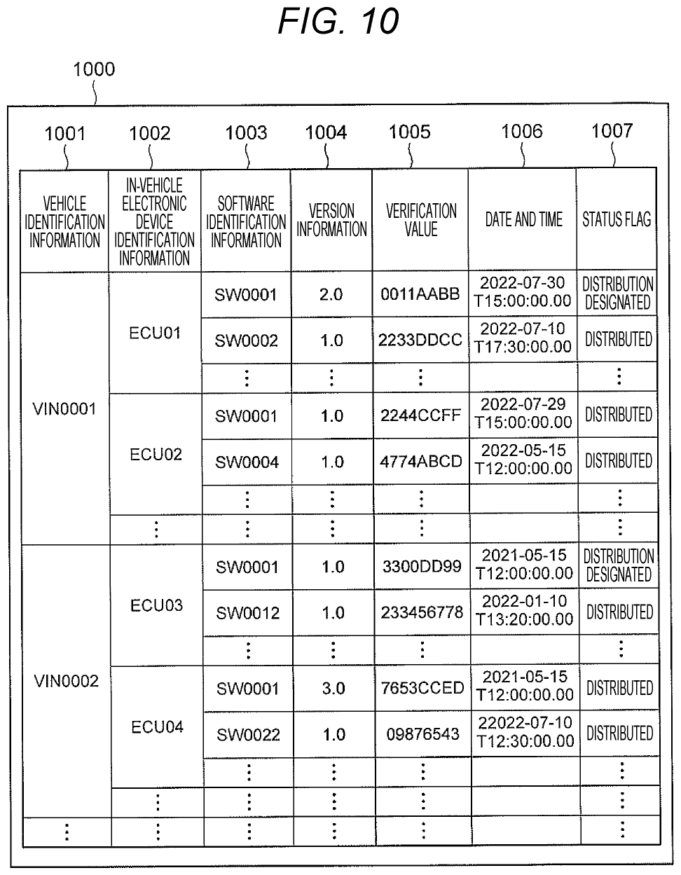

FIG. 10 is a diagram illustrating an example of vehicle management information stored in the vehicle information storage unit 107 of the management center 10. The vehicle management information 1000 includes fields such as vehicle identification information 1001, in-vehicle electronic device identification information 1002, software identification information 1003, version information 1004, a verification value 1005, date and time 1006, and a status flag 1007. A combination of values of the respective fields in one line indicates an entry related to one in-vehicle software.

As the vehicle identification information 1001, a vehicle identifier such as VIN is displayed, for example. As the in-vehicle electronic device identification information 1002, an identifier of the in-vehicle electronic device such as ECU ID is displayed. As the software identification information 1003, a software identifier such as a software name or a software ID of in-vehicle software is displayed.

As the version information 1004, the version number of the in-vehicle software is displayed. As the verification value 1005, a value for verification of the in-vehicle software is displayed. Although examples of the value for verification include a hash value, a checksum, a MAC value, and a digital signature value of the in-vehicle software, these methods may be combined, and the verification value is not limited to these methods. As the date and time 1006, a reception date and time, a distribution date and time, an installation date and time, and the like of the in-vehicle software are displayed. Alternatively, each date and time may be combined, and the date and time is not limited to the above. Although examples of a display format of the date and time include IS08601, the display format is not limited thereto.

As the status flag 1007, an application status of the in-vehicle software is displayed. Although examples of the application status include newly arrived, distribution designated, distributed, decrypted, and installed, the examples may be combined, and the application status is not limited the examples. Components of the vehicle management information 1000 are not limited to the above, and the order of the components is not limited to the above.

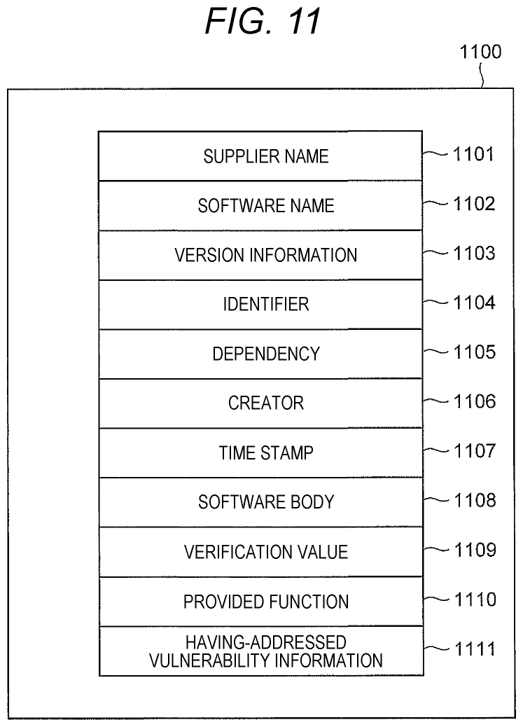

FIG. 11 is a diagram illustrating an example of software information stored in the update software storage unit 108 of the management center 10. The update software information 1100 includes fields such as a supplier name 1101, a software name 1102, version information 1103, an identifier 1104, a dependency 1105, a creator 1106, a time stamp 1107, a software body 1108, a verification value 1109, a provided function 1110, and having-addressed vulnerability information 1111. A combination of the fields in one column indicates an entry of one in-vehicle software.

The supplier name 1101 is information indicating a name of a supplier that created the in-vehicle software. The software name 1102 is information indicating a name of the in-vehicle software. The version information 1103 indicates a version number of the in-vehicle software. The identifier 1104 is information on a software identifier, such as an ID of in-vehicle software, software identification (SWID), software package data exchange (SPDX), common platform emumeration (CPE), or cyclone DX.

Although the dependency 1105 is information indicating a combination with different in-vehicle software or a dependency relationship using text or a graph diagram, for example, it is not limited to the information. The creator 1106 is information indicating names of a supplier, department, a creator, and the like that have created the in-vehicle software, and is not limited the names. Although the time stamp 1107 is information indicating creation date and time of the in-vehicle software and has a format that is ISO8601, for example, the format is not limited to this format. The software body 1108 is data on the in-vehicle software itself.

The verification value 1109 is a value for verification of the in-vehicle software. Although examples of the value for verification include a hash value, a checksum, a MAC value, and a digital signature value of the in-vehicle software, these methods may be combined, and the verification value is not limited to these methods. The provided function 1110 is information indicating a function implemented by in-vehicle software. Although examples the information include a UN regulation number, a title, and an Rx software identification number (RXSWIN), a combination of these methods may be used, and the information is not limited to the above.

The having-addressed vulnerability information 1111 is information indicating vulnerability information addressed by the in-vehicle software. Although examples of the information include a common vulnerabilities and exposures (CVE) ID, an ID in an information sharing and analysis center (ISAC), and a vulnerability identification number of Japan vulnerability notes (JVN), the types of information may be combined, and the information is not limited to the above.

When these configurations, procedures, and data structures are implemented, using identification information on a vehicle or an in-vehicle electronic device as a decryption key not only requires no new key for updating or using in-vehicle software to be stored in a non-writable region of the vehicle, but also enables reducing a risk of erroneous setting of a key value. Additionally, a management center uses identification information on the vehicle or the in-vehicle electronic device as the decryption key, so that the number of keys managed for each vehicle is not increased, and thus a load of key management can be prevented from increasing.

The present invention is not limited to the above embodiment, and various modifications can be made within the scope of the gist of the present invention.

For example, when a plurality of in-vehicle electronic devices has a hierarchical structure in a vehicle, one of the in-vehicle electronic devices in the uppermost layer may perform decryption processing of encrypted update software (steps S801 to S803 in FIG. 8) and transmit the update software to another of the in-vehicle electronic devices in a lower layer, or the decryption processing of the encrypted update software (steps S801 to S810) may be performed by the in-vehicle electronic devices in order from that in the uppermost layer. When identification information to be used for decryption and a part of the identification information are stored in different in-vehicle electronic devices, these types of information may be received by corresponding one of the in-vehicle electronic devices that performs the decryption processing (step S802).

The processing unit and the storage unit of the management center may be implemented by one computer or may be implemented as a system including a plurality of computers. The management center and the vehicle may be connected by a wireless communication network, or a wired communication network such as a wired LAN. When receiving a plurality of pieces of update software, the management center may collectively repeat the processing steps of S501, S502, and S503 multiple times, or may repeat each processing step multiple times, and then may perform the next processing step. Alternatively, these processes may be combined.

The update software may be delivered from the supplier of the software to the management center, or the update software may be created in the management center.

According to the embodiment of the present invention described above, operational effects below are achieved.

(1) An information processing device according to the present invention includes: a storage unit that stores a unique number that identifies a vehicle or an in-vehicle electronic device; a vehicle selection unit that selects a vehicle to which update software is applied; a key generation unit that generates a secret key using, as a public key, at least one of the unique number of the vehicle selected and the unique number of the in-vehicle electronic device mounted on the vehicle; an encryption unit that encrypts the update software using the secret key to generate encrypted update software; and a distribution unit that distributes the encrypted update software to the vehicle.

According to the configuration above, using identification information on a vehicle or an in-vehicle electronic device as a decryption key not only requires no new key for updating or using in-vehicle software to be stored in a non-writable region of the vehicle, but also enables reducing a risk of erroneous setting of a key value. Additionally, a management center uses identification information on the vehicle or the in-vehicle electronic device as the decryption key, so that the number of keys managed for each vehicle is not increased, and thus a load of key management can be prevented from increasing.

(2) The unique number includes vehicle identification information, an in-vehicle electronic device number, or a software number. Consequently, several types of information can be used as the decryption key, and a defense against an attack from a third party can be secured.

(3) The key generation unit generates the secret key using attribute-based encryption. Using the attribute-based encryption enables a unique number such vehicle identification information to be used as a decryption key, so that a key for decryption is not required to be separately prepared.

(4) An information processing system according to the present invention includes the information processing device according to item (1), and an in-vehicle electronic device mounted on a vehicle that receives update software, the in-vehicle electronic device including: a reception unit that receives the encrypted update software; an in-vehicle storage unit having a non-rewritable region in which the unique number is held; and a decryption verification unit that decrypts and verifies the encrypted update software using the unique number held.

The above configuration enables constructing a system in which the encrypted update software generated by the information processing device according to item (1) is received and decrypted by the vehicle.

(5) The decryption verification unit stops software update processing when decryption or verification using the unique number fails. This configuration enables suppressing wasteful consumption of resources.

(6) The in-vehicle electronic device described in item (4) is also standalone within the scope of the present invention.

The technical scope of the present invention is not limited to the scope described in the above embodiment, and includes various modifications without departing from the main features of the present invention. Thus, the above-described embodiment is merely an example and should not be interpreted in a limited manner. Additionally, another configuration can be added, deleted, and replaced for a part of the configuration of each embodiment to form configurations all of which are within the scope of the present invention.

### REFERENCE SIGNS LIST

10 management center (information processing device)
20 vehicle
30 in-vehicle electronic device
103 vehicle selection unit
104 key generation unit
105 encryption unit
106 distribution unit
107 vehicle information storage unit
108 update software storage unit
109 distribution software storage unit
302 reception unit
303 decryption verification unit
308 in-vehicle storage unit

1. An information processing device comprising:
a storage unit that stores a unique number that identifies a vehicle or an in-vehicle electronic device;
a vehicle selection unit that selects a vehicle to which update software is applied;
a key generation unit that generates a secret key using, as a public key, at least one of the unique number of the vehicle selected and the unique number of the in-vehicle electronic device mounted on the vehicle;
an encryption unit that encrypts the update software using the secret key to generate encrypted update software; and
a distribution unit that distributes the encrypted update software to the vehicle.

2. The information processing device according to claim 1, wherein
unique number includes vehicle identification information, an in-vehicle electronic device number, or a software number.

3. The information processing device according to claim 1, wherein
the key generation unit generates the secret key using attribute-based encryption.

4. An information processing system comprising: the information processing device according to claim 1; and an in-vehicle electronic device mounted on a vehicle that receives update software,
the in-vehicle electronic device including:
a reception unit that receives the encrypted update software;
an in-vehicle storage unit having a non-rewritable region in which the unique number is held; and
a decryption verification unit that decrypts and verifies the encrypted update software using the unique number held.

5. The information processing system according to claim 4, wherein
the decryption verification unit stops software update processing when decryption or verification using the unique number fails.

6. An in-vehicle electronic device mounted on a vehicle, the in-vehicle electronic device comprising:
a reception unit that receives encrypted update software encrypted with a secret key using, as a public key, at least one of unique numbers that identify the vehicle or the in-vehicle electronic device;
an in-vehicle storage unit having a non-rewritable region in which the unique number is held; and
a decryption verification unit that decrypts and verifies the encrypted update software using the unique number held.

7. The in-vehicle electronic device according to claim 6, wherein
the decryption verification unit stops software update processing when decryption or verification using the unique number fails.

8. The in-vehicle electronic device according to claim 6, wherein
the unique number includes vehicle identification information, an in-vehicle device number, or a software number.

9. The in-vehicle electronic device according to claim 6, wherein
the secret key is generated using attribute-based encryption.
